(19) United States
(12) Patent Application Publication
(10) Pub. No.: US 2026/0031407 A1
(43) Pub. Date: Jan. 29, 2026

(54) SECONDARY BATTERY, ELECTRONIC DEVICE, AND ELECTRODE PLATE MANUFACTURING METHOD

(71) Applicant: Dongguan Amperex Technology Limited, Dongguan (CN)

(72) Inventors: Shixi Yu, Dongguan (CN); Xinpeng Yang, Dongguan (CN); Yimei Xiong, Dongguan (CN)

(73) Assignee: Dongguan Amperex Technology Limited, Dongguan (CN)

(21) Appl. No.: 19/280,697

(22) Filed: Jul. 25, 2025

(30) Foreign Application Priority Data
Jul. 26, 2024 (CN) 202411021153.4

(51) Int. Cl. H01M 10/0587; H01M 4/134; H01M 4/38; H01M 10/0525

(52) U.S. Cl. CPC H01M 10/0587; H01M 4/134; H01M 4/386; H01M 10/0525

(57) ABSTRACT

An electrode assembly includes a first electrode plate, a second electrode plate, and a separator that are wound to form a jelly-roll structure. The electrode assembly includes a first straight portion, a first curved portion, a second straight portion, and a second curved portion. The first straight portion and the second straight portion each include a first part, a second part, and a third part. Along a thickness direction of the first electrode plate, the first electrode plate is locally recessed in at least one of the first curved portion, the second curved portion, the first part, or the third part, so as to form a first recessed portion or portions. The first electrode plate at the first recessed portion is locally recessed to form a second recessed portion or portions. The first recessed portion and the second recessed portion are recessed in the same direction.

### CROSS REFERENCE TO RELATED APPLICATION

This application claims priority to the Chinese Patent Application Ser. No. 202411021153.4, filed on Jul. 26, 2024, the content of which is incorporated herein by reference in its entirety.

### TECHNICAL FIELD

This application relates to the technical field of energy storage, and in particular, to a secondary battery, an electronic device, and an electrode plate manufacturing method.

### BACKGROUND

A jelly-roll structure of an electrode assembly is the most widely used structure in lithium-ion batteries currently. During charge-and-discharge cycles of a battery, delithiation and lithiation of an electrode plate causes the electrode plate to expand and contract repeatedly, thereby causing a bare cell to expand and contract repeatedly. The expansion of the electrode plate gives rise to stress inside the electrode plate, and is prone to cause the electrode plate to tear up.

### SUMMARY

In view of the above situation, it is necessary to provide a secondary battery, an electronic device, and an electrode plate manufacturing method to reduce stress concentration on an electrode plate caused by expansion.

According to a first aspect, an embodiment of this application provides a secondary battery. The secondary battery includes a housing and an electrode assembly. The electrode assembly is disposed in the housing. The electrode assembly includes a first electrode plate, a second electrode plate, and a separator disposed between the first electrode plate and the second electrode plate. The first electrode plate, the second electrode plate, and the separator are stacked and wound to form a jelly-roll structure. Along a winding direction of the electrode assembly, the electrode assembly includes a first straight portion, a first curved portion, a second straight portion, and a second curved portion that are disposed sequentially. The first straight portion and the second straight portion each include a first part, a second part, and a third part disposed sequentially. The first part is connected to the first curved portion and the second part. The third part is connected to the second curved portion and the second part. Along the winding direction of the electrode assembly, a length of the first part is D₁, and a length of the third part is D₂, satisfying: 0≤D₁≤5 mm, and 0≤D₂≤5 mm. Along a thickness direction of the first electrode plate, the first electrode plate is locally recessed in at least one of the first curved portion, the second curved portion, the first part, or the third part, so as to form a first recessed portion or portions and a second recessed portion or portions. The second recessed portion is located in the first recessed portion. The first recessed portion and the second recessed portion are recessed in the same direction.

In the secondary battery, the first electrode plate at the first recessed portion can exert a supporting force to form a clearance between the separator and the first electrode plate to provide deformation space for the electrode assembly as a whole, thereby releasing stress and reducing stress accumulation. The first curved portion, the second curved portion, the first part, and the third part are stress concentration points of the electrode assembly. The first recessed portion is located in at least one of the first curved portion, the second curved portion, the first part, or the third part, thereby being more conducive to stress release in contrast to a practice in which the first recessed portion is located in other positions of the electrode assembly. The second recessed portion provided on the basis of the first recessed portion can further increase the clearance between the first electrode plate and the separator to provide deformation space for the electrode assembly as a whole, thereby releasing stress and further reducing the probability of damage to the first electrode plate and the second electrode plate. Therefore, the first recessed portion and the second recessed portion prolong the service life of the secondary battery.

In one or more embodiments of this application, at least one of the first recessed portions is provided at the first curved portion. This releases the stress at the first curved portion, and reduces the probability of damage to the first electrode plate or the second electrode plate at the first curved portion due to stress concentration at the first curved portion.

In one or more embodiments of this application, at least one of the first recessed portions is provided at the second curved portion. This releases the stress at the second curved portion, and reduces the probability of damage to the first electrode plate or the second electrode plate at the second curved portion due to stress concentration at the second curved portion.

In one or more embodiments of this application, along the winding direction of the electrode assembly, an outermost turn of the first electrode plate is provided with the first recessed portion. The first recessed portion provided at the outermost turn of the first electrode plate can reduce the probability that the first recessed portion is pulled and flattened by the stress on the first electrode plate during the winding of the electrode assembly, thereby maintaining the shape of the first recessed portion during the winding of the electrode assembly.

In one or more embodiments of this application, a second turn from the outside of the first electrode plate is provided with the first recessed portion. The first recessed portion provided on the second turn from the outside of the first electrode plate can reduce the probability that the first recessed portion is pulled and flattened by the stress on the first electrode plate during the winding of the electrode assembly, thereby maintaining the shape of the first recessed portion during the winding of the electrode assembly.

In one or more embodiments of this application, along a winding center axis direction of the electrode assembly, the first recessed portion extends from one side of the first electrode plate to another side of the first electrode plate. The first electrode plate at the first recessed portion can be stretched and deformed under stress, thereby releasing at least a part of the stress and reducing the probability of damage to the first electrode plate and the second electrode plate due to stress concentration.

In one or more embodiments of this application, the second recessed portion is in a shape that is at least one of a dot-shaped recess, a reticular recess, or a striped recess.

In one or more embodiments of this application, there are a plurality of the first recessed portions. The number of the first recessed portions is not excessively small, thereby increasing the stress release value.

In one or more embodiments of this application, there are a plurality of second recessed portions within at least one of the first recessed portions. The number of the second recessed portions is not excessively small, thereby exerting a sufficient supporting force to form a clearance between the first electrode plate and the separator, and in turn, releasing stress during expansion of the electrode assembly.

In one or more embodiments of this application, the first recessed portion includes a first edge and a second edge that are disposed opposite to each other along a length direction of the first electrode plate. Among the plurality of second recessed portions, a minimum distance between a second recessed portion closest to the first edge and the first edge is W₁, satisfying: 1 mm≤W₁≤5 mm. Among the plurality of second recessed portions, a minimum distance between a second recessed portion closest to the second edge and the second edge is W₂, satisfying: 1 mm≤W₂≤5 mm. With W₁ being greater than or equal to 1 mm and W₂ being greater than or equal to 1 mm, the distance between the edge of the first recessed portion and the second recessed portion is not excessively small, thereby reducing the probability of damage to the first electrode plate during press-forming of the second recessed portion. With W₁ being less than or equal to 5 mm and W₂ being less than or equal to 5 mm, the distance between the edge of the first recessed portion and the second recessed portion is not excessively large, thereby improving the supporting effect of the second recessed portion for the separator, and releasing stress during expansion of the electrode assembly.

In one or more embodiments of this application, when the first electrode plate is in an unwound state, a diameter of an inscribed circle of an opening of the second recessed portion is R, satisfying 1 mm≤R≤5 mm. When R is greater than or equal to 1 mm, the pressure on the first electrode plate 21 during press-forming of the second recessed portion 214 is not excessively large, thereby reducing the probability of damage to the first electrode plate 21 during press-forming of the second recessed portion 214. When R is less than or equal to 5 mm, each second recessed portion does not occupy an excessively large area on the surface of the first electrode plate, thereby enabling arrangement of a larger number of second recessed portions, and in turn, improving the supporting effect of the first electrode plate at the second recessed portion for the separator.

In one or more embodiments of this application, there are a plurality of the second recessed portions within at least one of the first recessed portions, and a distance between two adjacent second recessed portions within the same first recessed portion is D₃, satisfying: 0.5 mm≤D₃≤10 mm. When D₃ is set to be greater than or equal to 0.5 mm, the distance between two adjacent second recessed portions is made not excessively short, thereby reducing the probability of damage to the first electrode plate due to the formation of the second recessed portion. When D₃ is set to be less than or equal to 10 mm, the distance between two adjacent second recessed portions is not excessively long, thereby increasing the number of second recessed portions per unit area of the first electrode plate, improving the supporting effect of the second recessed portion for the separator, and in turn, maintaining the clearance between the separator and the first electrode plate.

In one or more embodiments of this application, when the first electrode plate is in an unwound state, along the thickness direction of the first electrode plate, a depth of the first recessed portion is H₁, satisfying: 0.1 mm≤H₁≤1.5 mm. When H₁ is greater than or equal to 0.1 mm, the degree of recessing of the first electrode plate at the first recessed portion is not excessively small, and the clearance between the first electrode plate and the separator is not excessively small, thereby facilitating stress release. When H₁ is less than or equal to 1.5 mm, the degree of recessing of the first electrode plate at the first recessed portion is not excessively great, thereby reducing the probability of damage to the first electrode plate during press-forming of the first recessed portion.

In one or more embodiments of this application, when the first electrode plate is in an unwound state, along the thickness direction of the first electrode plate, a depth of the second recessed portion is H₂, satisfying: 0.1 mm≤H₂≤1.5 mm. When H₂ is greater than or equal to 0.1 mm, the degree of recessing of the first electrode plate at the second recessed portion is not excessively small, and the clearance between the first electrode plate and the separator is not excessively small, thereby facilitating stress release. When H₂ is less than or equal to 1.5 mm, the degree of recessing of the first electrode plate at the second recessed portion is not excessively great, thereby reducing the probability of damage to the first electrode plate during press-forming of the second recessed portion.

In one or more embodiments of this application, the first recessed portion is recessed toward a winding center of the electrode assembly, and the second recessed portion is recessed toward the winding center of the electrode assembly. This makes it convenient for the first electrode plate at the first recessed portion and the first electrode plate at the second recessed portion to be in contact with and connected to the separator, so as to exert a supporting force to form a clearance.

In one or more embodiments of this application, along a thickness direction of the second electrode plate, the second electrode plate is locally recessed in at least one of the first curved portion, the second curved portion, the first part, or the third part, so as to form a third recessed portion. The second electrode plate at the third recessed portion is locally recessed to form a fourth recessed portion. The fourth recessed portion and the third recessed portion are recessed in the same direction. The second electrode plate at the third recessed portion can exert a supporting force to form a clearance between the separator and the second electrode plate to provide deformation space for the electrode assembly as a whole, thereby releasing stress and reducing stress accumulation. In addition, the first curved portion, the second curved portion, the first part, and the third part are stress concentration points of the electrode assembly. The third recessed portion is located in at least one of the first curved portion, the second curved portion, the first part, or the third part, thereby being more conducive to stress release in contrast to a practice in which the recessed portion is located in other positions of the electrode assembly. The fourth recessed portion provided on the basis of the third recessed portion can further increase the clearance between the second electrode plate and the separator to provide deformation space for the electrode assembly as a whole, thereby releasing stress and further reducing the probability of damage to the first electrode plate and the second electrode plate.

In one or more embodiments of this application, of the first electrode plate and the second electrode plate, one is a positive electrode plate, and the other is a negative electrode plate. The negative electrode plate includes a negative current collector and a negative active material layer that are stacked together. A material of the negative active material layer includes silicon. Based on a mass of the negative active material layer, a mass percent of the silicon is 5% to 50%. The mass percent of silicon being greater than or equal to 5% increases the energy density of the secondary battery. The mass percent of silicon being less than or equal to 50% reduces the stress generated during silicon expansion, and reduces the probability of damage to the first electrode plate and the second electrode plate. The first recessed portion and the second recessed portion provided on the first electrode plate release the stress inside the electrode assembly, and reduce the probability of damage to the first electrode plate and the second electrode plate, thereby prolonging the service life of the silicon-based secondary battery.

According to a second aspect, an embodiment of this application provides an electronic device. The electronic device includes the secondary battery disclosed in any one of the above embodiments.

According to a third aspect, an embodiment of this application provides an electrode plate manufacturing method, configured to manufacture the first electrode plate referred to in any one of the above embodiments. The electrode plate manufacturing method includes the following steps: pressing, when an electrode plate is in an unwound state, a local part of the electrode plate along a thickness direction of the electrode plate to form the second recessed portion on the electrode plate, where the second recessed portion is recessed along the thickness direction of the electrode plate, and pressing, along the thickness direction of the electrode plate, an entire region at which the second recessed portion is located, so as to form the first recessed portion that is recessed along the thickness direction of the electrode plate; or, pressing, when an electrode plate is in an unwound state, a local part of the electrode plate along a thickness direction of the electrode plate to form the first recessed portion on the electrode plate, where the first recessed portion is recessed along the thickness direction of the electrode plate, and pressing, along the thickness direction of the electrode plate, the electrode plate at the first recessed portion to form the second recessed portion that is recessed along the thickness direction of the electrode plate.

In the electrode plate manufacturing method, the electrode plate is pressed twice. In other words, the second recessed portion is formed first by pressing, and then the first recessed portion is formed by pressing; or, the first recessed portion is formed first by pressing, and then the second recessed portion is formed by pressing. Compared with a practice in which the first recessed portion and the second recessed portion are formed by pressing at the same time, the technical solution hereof can reduce the probability of the electrode plate being damaged or even fractured during the pressing, thereby improving the yield rate of the electrode assembly during manufacturing.

### BRIEF DESCRIPTION OF DRAWINGS

FIG. 1 is a schematic structural diagram of a secondary battery according to an embodiment of this application;

FIG. 2 is a schematic structural diagram of an electrode assembly according to an embodiment of this application;

FIG. 3 is a schematic structural diagram of a first electrode plate in an unwound state according to an embodiment of this application;

FIG. 4 is a close-up view of a position A shown in FIG. 3;

FIG. 5 is a schematic structural diagram of a first electrode plate in an unwound state according to an embodiment of this application;

FIG. 6 is a close-up view of a position B shown in FIG. 5;

FIG. 7 is a cross-sectional schematic view taken along a section line I-I shown in FIG. 3;

FIG. 8 is a schematic structural diagram of a second electrode plate in an unwound state according to an embodiment of this application;

FIG. 9 is a cross-sectional schematic view taken along a section line II-II shown in FIG. 8;

FIG. 10 is a schematic structural diagram of a first electrode plate in an unwound state according to an embodiment of this application;

FIG. 11 is a schematic structural diagram of a first electrode plate in an unwound state according to an embodiment of this application; and

FIG. 12 is a schematic structural diagram of an electronic device according to an embodiment of this application.

### LIST OF REFERENCE NUMERALS

secondary battery 100
housing 10
electrode assembly 20
first electrode plate 21
first current collector 211
first active material layer 212
first recessed portion 213
first edge 2131
second edge 2132
second recessed portion 214
second electrode plate 22
second current collector 221
second active material layer 222
third recessed portion 223
fourth recessed portion 224
separator 23
first straight portion 201
second straight portion 202
first curved portion 203
second curved portion 204
first part 2011
second part 2012
third part 2013
electronic device 1000

This application is further described below with reference to the following specific embodiments and the foregoing drawings.

### DETAILED DESCRIPTION

The following describes the technical solutions in the embodiments of this application with reference to the drawings hereto. Evidently, the described embodiments are merely a part of but not all of the embodiments of this application.

It is hereby noted that a component considered to be “connected to” another component may be directly connected to the other component or may be connected to the other component through an intermediate component. A component considered to be “disposed on” another component may be directly disposed on the other component or may be disposed on the other component through an intermediate component. The term “and/or” used herein includes any and all combinations of one or more relevant items enumerated.

Unless otherwise defined, all technical and scientific terms used herein bear the same meanings as what is normally understood by a person skilled in the technical field of this application. The terms used in the specification of this application are merely intended to describe specific embodiments but not to limit this application.

In the description of embodiments of this application, the technical terms “first” and “second” are merely intended to distinguish between different items but not intended to indicate or imply relative importance or implicitly specify the number of the indicated technical features, specific order, or order of precedence. In the description of some embodiments of this application, unless otherwise expressly specified, “a plurality of” means two or more.

Reference to an “embodiment” herein means that a specific feature, structure or characteristic described with reference to this embodiment may be included in at least one embodiment of this application. Reference to this term in different places in the specification does not necessarily represent the same embodiment, nor does it represent an independent or alternative embodiment in a mutually exclusive relationship with other embodiments. To the extent that no conflict occurs, different embodiments of this application may be combined with each other.

It is hereby noted that, dimensions such as thickness, length, and width of various components in some embodiments of this application shown in the drawings, and dimensions such as overall thickness, length, and width of an integrated device are merely illustrative descriptions, but do not constitute any limitation on this application.

An embodiment of this application provides a secondary battery. The secondary battery includes a housing and an electrode assembly. The electrode assembly is disposed in the housing. The electrode assembly includes a first electrode plate, a second electrode plate, and a separator disposed between the first electrode plate and the second electrode plate. The first electrode plate, the second electrode plate, and the separator are stacked and wound to form a jelly-roll structure. Along a winding direction of the electrode assembly, the electrode assembly includes a first straight portion, a first curved portion, a second straight portion, and a second curved portion that are disposed sequentially. The first straight portion and the second straight portion each include a first part, a second part, and a third part disposed sequentially. The first part is connected to the first curved portion and the second part. The third part is connected to the second curved portion and the second part. Along the winding direction of the electrode assembly, a length of the first part is D₁, and a length of the third part is D₂, satisfying: 0≤D₁≤5 mm, and 0≤D₂≤5 mm. Along a thickness direction of the first electrode plate, the first electrode plate is locally recessed in at least one of the first curved portion, the second curved portion, the first part, or the third part, so as to form a first recessed portion or portions and a second recessed portion or portions. The second recessed portion is located in the first recessed portion. The first recessed portion and the second recessed portion are recessed in the same direction.

In the secondary battery, the first electrode plate at the first recessed portion can exert a supporting force to form a clearance between the separator and the first electrode plate to provide deformation space for the electrode assembly as a whole, thereby releasing stress and reducing stress accumulation. The first curved portion, the second curved portion, the first part, and the third part are stress concentration points of the electrode assembly. The first recessed portion is located in at least one of the first curved portion, the second curved portion, the first part, or the third part, thereby being more conducive to stress release in contrast to a practice in which the first recessed portion is located in other positions of the electrode assembly. The second recessed portion provided on the basis of the first recessed portion can further increase the clearance between the first electrode plate and the separator to provide deformation space for the electrode assembly as a whole, thereby releasing stress and further reducing the probability of damage to the first electrode plate and the second electrode plate. Therefore, the first recessed portion and the second recessed portion prolong the service life of the secondary battery.

The following further describes the embodiments of this application with reference to drawings.

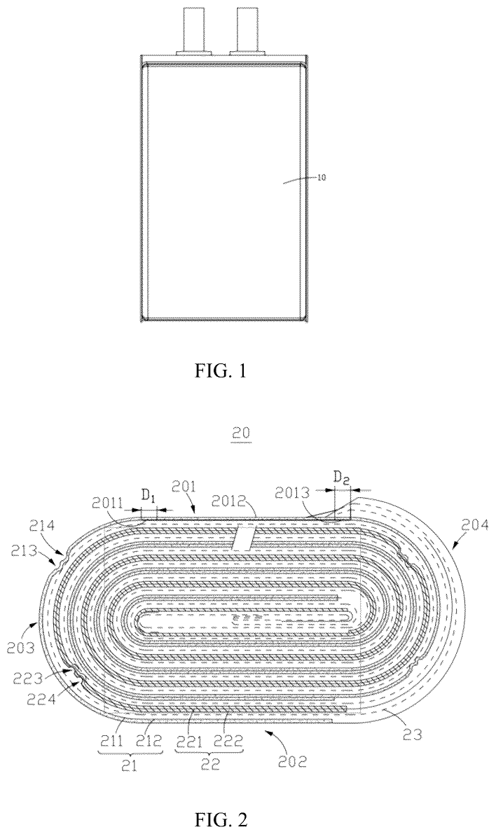

As shown in FIG. 1 and FIG. 2, an embodiment of this application provides a secondary battery 100, including a housing 10 and an electrode assembly 20. The electrode assembly 20 is disposed in the housing 10.

In some embodiments, the housing 10 is a flexible packaging bag such as an aluminum laminated film. In other embodiments, the housing 10 is a hard shell such as a plastic shell, or is a metal shell containing at least one of a steel alloy, an aluminum alloy, or a copper alloy.

In some embodiments, as shown in FIG. 2, the electrode assembly 20 includes a first electrode plate 21, a second electrode plate 22, and a separator 23 disposed between the first electrode plate 21 and the second electrode plate 22. The first electrode plate 21, the second electrode plate 22, and the separator 23 are stacked and wound to form a jelly-roll structure. Along a winding direction of the electrode assembly 20, the electrode assembly 20 includes a first straight portion 201, a first curved portion 203, a second straight portion 202, and a second curved portion 204 that are disposed sequentially. Viewed along a thickness direction of the first electrode plate 21, outer surfaces of the first straight portion 201 and the second curved portion 204 are flat straight surfaces, and outer surfaces of the first curved portion 203 and the second curved portion 204 are arcuate surfaces. A junction between the first curved portion 203 and the first straight portion 201, a junction between the first curved portion 203 and the second straight portion 202, a junction between the second curved portion 204 and the first straight portion 201, and a junction between the second curved portion 204 and the second straight portion 202 are all junctions between a flat straight surface and an arcuate surface.

In some embodiments, as shown in FIG. 2, the first electrode plate 21 includes a first current collector 211 and a first active material layer 212 that are stacked up.

In some embodiments, as shown in FIG. 2, the second electrode plate 22 includes a second current collector 221 and a second active material layer 222 that are stacked up.

In some embodiments, of the first electrode plate 21 and the second electrode plate 22, one is a positive electrode plate, and the other is a negative electrode plate. When the first electrode plate 21 is a positive electrode plate, the first current collector 211 is a positive current collector, and the first active material layer 212 is a positive active material layer. When the first electrode plate 21 is a negative electrode plate, the first current collector 211 is a negative current collector, and the first active material layer 212 is a negative active material layer. When the second electrode plate 22 is a positive electrode plate, the second current collector 221 is a positive current collector, and the second active material layer 222 is a positive active material layer. When the second electrode plate 22 is a negative electrode plate, the second current collector 221 is a negative current collector, and the second active material layer 222 is a negative active material layer.

In some embodiments, both the positive current collector and the negative current collector are metal layers. As an example, the positive current collector may be a metal layer containing at least one of aluminum, nickel, tantalum, or titanium, such as aluminum foil. The negative current collector may be a metal layer containing at least one of copper, nickel, tantalum, or titanium, such as copper foil.

In some embodiments, the separator 23 contains an insulating substrate such as a polyethylene film, a polypropylene film, a polyester film, or a polyimide film, so as to serve a function of isolation between the positive electrode plate and the negative electrode plate.

In some embodiments, the secondary battery 100 further includes an electrolyte solution. The electrolyte solution is injected as a filler in the housing 10.

In some embodiments, the electrolyte solution includes an electrolyte salt. The electrolyte salt includes at least one of an organic lithium salt or an inorganic lithium salt.

In some embodiments, the electrolyte salt includes, but is not limited to, at least one of lithium hexafluorophosphate (LiPF₆), lithium bis(trifluoromethanesulfonyl)imide LiN(CF₃SO₂)₂ (LiTFSI), lithium bis(fluorosulfonyl)imide Li(N(SO₂F)₂) (LiFSI), lithium hexafluorocesium oxide (LiCsF₆), lithium perchlorate LiClO₄, or lithium trifluoromethanesulfonate (LiCF₃SO₃).

In some embodiments, as shown in FIG. 2, the first straight portion 201 and the second straight portion 202 each include a first part 2011, a second part 2012, and a third part 2013 disposed sequentially. The first part 2011 is connected to the first curved portion 203 and the second part 2012. The third part 2013 is connected to the second curved portion 204 and the second part 2012. Along the winding direction of the electrode assembly 20, the length of the first part 2011 is D₁, and the length of the third part 2013 is D₂, satisfying: 0≤D₁≤5 mm, and 0≤D₂≤5 mm. For the first straight portion 201, a starting point for calculating the length of the first part 2011 of the first straight portion is a junction between the first straight portion 201 and the first curved portion 203, and a starting point for calculating the length of the third part 2013 of the first straight portion is a junction between the first straight portion 201 and the second curved portion 204. For the second straight portion 202, a starting point for calculating the length of the first part 2011 of the second straight portion is a junction between the second straight portion 202 and the first curved portion 203, and a starting point for calculating the length of the third part 2013 of the second straight portion is a junction between the second straight portion 202 and the second curved portion 204.

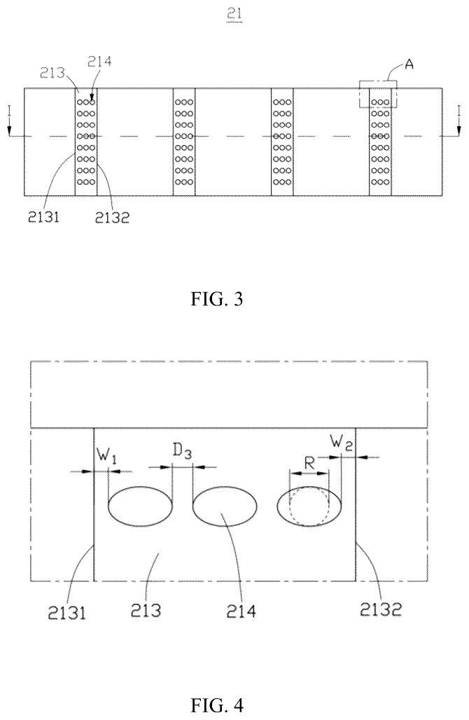

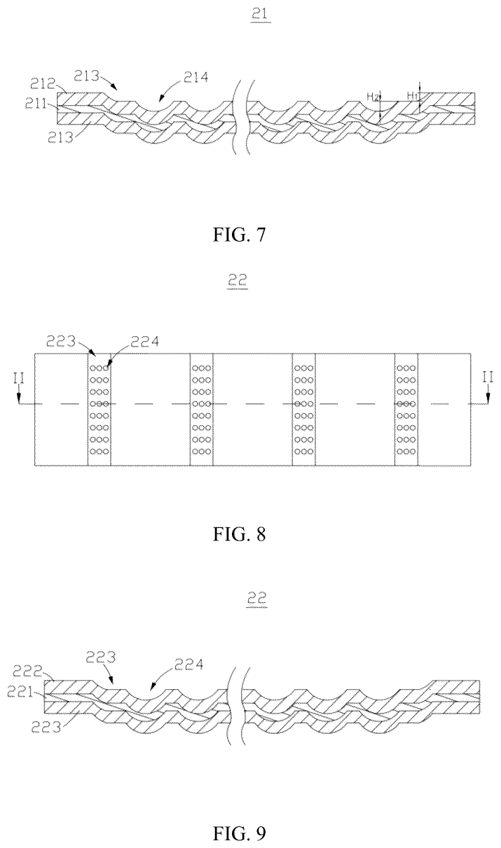

As an example of the distance value, D₁ may be any one of 0.5 mm, 1 mm, 1.5 mm, 2 mm, 2.5 mm, 3 mm, 3.5 mm, 4 mm, or 4.5 mm; and D₂ may be any one of 0.5 mm, 1 mm, 1.5 mm, 2 mm, 2.5 mm, 3 mm, 3.5 mm, 4 mm, or 4.5 mm. In some embodiments, as shown in FIG. 2, FIG. 3, and FIG. 7, along the thickness direction of the first electrode plate 21, the first electrode plate 21 is locally recessed in at least one of the first curved portion 203, the second curved portion 204, the first part 2011, or the third part 2013, so as to form a first recessed portion 213. When the first electrode plate 21 or the second electrode plate 22 expands during charging and discharging, the first electrode plate 21, the second electrode plate 22, and the separator 23 interact with each other to exert stress on the electrode assembly 20 as a whole. The first electrode plate 21 at the first recessed portion 213 can exert a supporting force to form a clearance between the separator 23 and the first electrode plate 21 to provide deformation space for the electrode assembly 20 as a whole, thereby releasing stress and reducing stress accumulation. In addition, the first curved portion 203, the second curved portion 204, the first part 2011, and the third part 2013 are stress concentration points of the electrode assembly 20. The first recessed portion 213 is located in at least one of the first curved portion 203, the second curved portion 204, the first part 2011, or the third part 2013, thereby being more conducive to stress release in contrast to a practice in which the recessed portion is located in other positions of the electrode assembly 20. In this way, the first recessed portion 213 reduces the probability of damage to the first electrode plate 21 and the second electrode plate 22, and prolongs the service life of the secondary battery 100.

In some embodiments, as shown in FIG. 2, FIG. 3, and FIG. 7, the first electrode plate 21 is locally recessed to form a second recessed portion 214. The second recessed portion 214 is located in the first recessed portion 213. The second recessed portion 214 and the first recessed portion 213 are recessed in the same direction. The second recessed portion 214 provided on the basis of the first recessed portion 213 can further increase the clearance between the first electrode plate 21 and the separator 23 to provide deformation space for the electrode assembly 20 as a whole, thereby releasing stress and further reducing the probability of damage to the first electrode plate 21 and the second electrode plate 22.

In some embodiments, at least one of the first recessed portions 213 is provided at the first curved portion 203. This releases the stress at the first curved portion 203 and reduces the probability of damage to the first electrode plate 21 or the second electrode plate 22 at the first curved portion 203 due to stress concentration at the first curved portion 203.

In some embodiments, at least one of the first recessed portions 213 is provided at the second curved portion 204. This releases the stress at the second curved portion 204, and reduces the probability of damage to the first electrode plate 21 or the second electrode plate 22 at the second curved portion due to stress concentration at the second curved portion 204.

In some embodiments, along the winding direction of the electrode assembly 20, a plurality of turns of the first electrode plate 21 are provided with the first recessed portion 213. That the plurality of turns of the first electrode plate 21 are provided with the first recessed portion 213 increases the space between the first electrode plate 21 and the separator 23, thereby reducing stress accumulation, and in turn, reducing the probability of damage to the first electrode plate 21 and the second electrode plate 22. In addition, because a plurality of turns of the first electrode plate 21 are provided with the first recessed portion 213, stress can be released from different positions of the electrode assembly 20, thereby reducing the probability of damage to the first electrode plate 21 or the second electrode plate 22 due to stress concentration.

In some embodiments, along the winding direction of the electrode assembly 20, the outermost turn of the first electrode plate 21 is provided with the first recessed portion 213. The first recessed portion 213 provided at the outermost turn of the first electrode plate 21 can reduce the probability that the first recessed portion 213 is pulled and flattened by the stress on the first electrode plate 21 during the winding of the electrode assembly 20, thereby maintaining the shape of the first recessed portion 213 during the winding of the electrode assembly 20.

In some embodiments, along the winding direction of the electrode assembly 20, a second turn from the outside of the first electrode plate 21 is provided with the first recessed portion 213. The first recessed portion 213 provided at the second turn from the outside of the first electrode plate 21 can reduce the probability that the first recessed portion 213 is pulled and flattened by the stress on the first electrode plate 21 during the winding of the electrode assembly 20, thereby maintaining the shape of the first recessed portion 213 during the winding of the electrode assembly 20.

In some embodiments, as shown in FIG. 3, along a winding center axis direction of the electrode assembly 20, the first recessed portion 213 extends from one side of the first electrode plate 21 to another side of the first electrode plate 21. The first electrode plate 21 at the first recessed portion 213 can be stretched and deformed under stress, thereby releasing at least a part of the stress and reducing the probability of damage to the first electrode plate 21 and the second electrode plate 22 due to stress concentration.

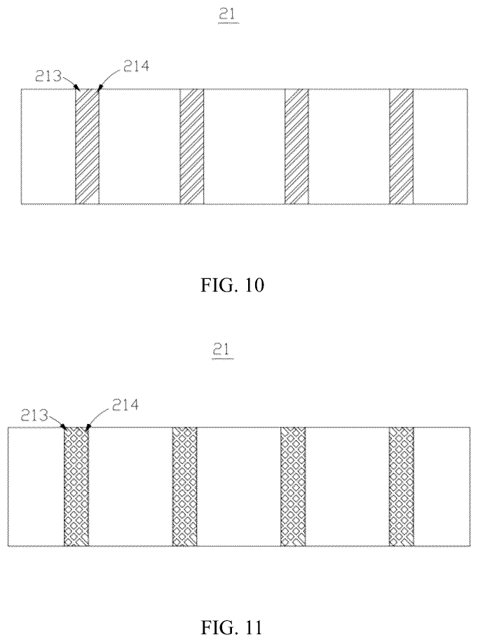

In some embodiments, the second recessed portion 214 is in a shape that is at least one of a dot-shaped recess (as shown in FIG. 3), a striped recess (as shown in FIG. 10), or a reticular recess (as shown in FIG. 11).

The second recessed portion 214 may be formed by pressing with an embossing roller. For example, dot-shaped recesses are formed on the first electrode plate 21 by pressing using a spherical embossing roller with spherical protrusions on the surface of the roller; reticular recesses are formed on the first electrode plate 21 by pressing using a reticular-surface embossing roller with reticular protrusions on the surface of the roller; striped recesses are formed on the first electrode plate 21 by pressing using a striped embossing roller with striped protrusions on the surface of the roller.

It is hereby noted that the shape of the second recessed portion 214 is not limited to the above examples.

In some embodiments, as shown in FIG. 3, there are a plurality of the first recessed portions 213. In this way, the number of the first recessed portions 213 is not excessively small, thereby increasing the stress release value.

In some embodiments, as shown in FIG. 3, there are a plurality of second recessed portions 214 within at least one of the first recessed portions 213. In this way, the number of the second recessed portions 214 is not excessively small, thereby exerting a sufficient supporting force to form a clearance between the first electrode plate 21 and the separator 23, and in turn, releasing stress during expansion of the electrode assembly 20.

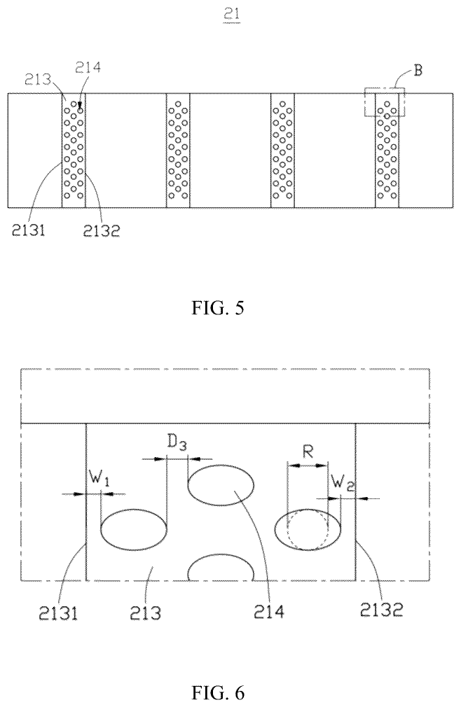

In some embodiments, as shown in FIG. 3 to FIG. 6, the first recessed portion 213 includes a first edge 2131 and a second edge 2132 that are disposed opposite to each other along the length direction of the first electrode plate 21. Among the plurality of second recessed portions 214, a minimum distance between a second recessed portion 214 closest to the first edge 2131 and the first edge 2131 is W₁, satisfying: 1 mm≤W₁≤5 mm. Among the plurality of second recessed portions 214, a minimum distance between a second recessed portion 214 closest to the second edge 2132 and the second edge 2132 is W₂, satisfying: 1 mm≤W₂≤5 mm. With W₁ being greater than or equal to 1 mm and W₂ being greater than or equal to 1 mm, the distance between the edge of the first recessed portion 213 and the second recessed portion 214 is not excessively small, thereby reducing the probability of damage to the first electrode plate 21 during press-forming of the second recessed portion 214. With W₁ being less than or equal to 5 mm and W₂ being less than or equal to 5 mm, the distance between the edge of the first recessed portion 213 and the second recessed portion 214 is not excessively large, thereby improving the supporting effect of the second recessed portion 214 for the separator 23, and releasing stress during expansion of the electrode assembly 20.

During actual measurement, an optical measurement microscope (OMM) may be used to observe the first electrode plate 21 at a magnification of 5× to 25×. A tangent line perpendicular to the length direction of the first electrode plate 21 is drawn at the edge of the second recessed portion 214. The second recessed portion 214 closest to the first edge 2131 and the second recessed portion 214 closest to the second edge 2132 are determined based on the distance from the tangent line to the first edge 2131 and the distance from the tangent line to the second edge 2132. Subsequently, a line segment that connects the second recessed portion 214 closest to the first edge 2131 and the first edge 2131 is drawn, and the line segment is parallel to the length direction of the first electrode plate 21 without crossing the second recessed portion 214. The length of the line segment is measured to obtain the value of W₁. When necessary, a plurality of line segments may be drawn, and the lengths thereof are measured and averaged out. A line segment that connects the second recessed portion 214 closest to the second edge 2132 and the second edge 2132 is drawn, and the line segment is parallel to the length direction of the first electrode plate 21 without crossing the second recessed portion 214. The length of the line segment is measured to obtain the value of W₂. When necessary, a plurality of line segments may be drawn, and the lengths thereof are measured and averaged out.

In some embodiments, as shown in FIG. 4, when the first electrode plate 21 is in an unwound state, the diameter of an inscribed circle of an opening of the second recessed portion 214 is R, satisfying 1 mm≤R≤5 mm. The size of the opening of the second recessed portion 214 can reflect the magnitude of the pressure borne by the first electrode plate 21 during press-forming of the second recessed portion 214. The smaller the opening of the second recessed portion 214, the greater the pressure borne by the first electrode plate 21 during press-forming of the second recessed portion 214, and the higher the probability of damage to the first electrode plate 21 during the press-forming. When R is greater than or equal to 1 mm, the pressure on the first electrode plate 21 during press-forming of the second recessed portion 214 is not excessively large, thereby reducing the probability of damage to the first electrode plate 21 during press-forming of the second recessed portion 214. When R is less than or equal to 5 mm, each second recessed portion 214 does not occupy an excessively large area on the surface of the first electrode plate 21, thereby enabling arrangement of a larger number of second recessed portions 214, and in turn, improving the supporting effect of the first electrode plate 21 at the second recessed portion 214 for the separator 23. It is hereby noted that the inscribed circle of the opening of the second recessed portion 214 is used for measuring the size of the opening of the second recessed portion 214 that is circular or non-circular. When the opening of the second recessed portion 214 is circular, the diameter of the inscribed circle of the opening is the diameter of the opening of the second recessed portion 214. When the opening of the second recessed portion 214 is non-circular, the inscribed circle of the opening may be defined by an existing mathematical method, the details of which are omitted here.

As an example of the diameter value, R may be any one of 1.5 mm, 2 mm, 2.5 mm, 3 mm, 3.5 mm, 4 mm, or 4.5 mm.

In some embodiments, as shown in FIG. 4, there are a plurality of second recessed portions 214 within at least one of the first recessed portions 213. A distance between two adjacent second recessed portions 214 within the same first recessed portion 213 is D₃, satisfying: 0.5 mm≤D₃≤10 mm. After the second recessed portion 214 is formed on the first electrode plate 21 by pressing, the structural strength of the first electrode plate 21 at the opening edge of the second recessed portion 214 is weakened. When D₃ is set to be greater than or equal to 0.5 mm, the distance between two adjacent second recessed portions 214 is made not excessively short, thereby reducing the probability of damage to the first electrode plate 21 due to the formation of the second recessed portion 214. When the distance between two adjacent second recessed portions 214 is excessively long, the separator 23 may fit at least a part of the surface of the second recessed portion 214, resulting in an excessively small clearance between the first electrode plate 21 and the separator 23, and affecting the effect of stress release. When D₃ is set to be less than or equal to 10 mm, the distance between two adjacent second recessed portions 214 is not excessively long, thereby increasing the number of second recessed portions 214 per unit area of the first electrode plate 21, improving the supporting effect of the second recessed portion 214 for the separator 23, and in turn, maintaining the clearance between the separator 23 and the first electrode plate 21. It is hereby noted that the distance between two adjacent second recessed portions 214 here means a minimum distance between points on the edges of the two adjacent second recessed portions 214. During actual measurement, a segment containing at least 2 second recessed portions 214 is taken from the first electrode plate 21 in the length direction of the first electrode plate. A concave surface of the first electrode plate 21 faces downward. The segment may be observed by using an optical measurement microscope (OMM) at a magnification of 5× to 25×. In the length direction of the first electrode plate 21, for two adjacent second recessed portions 214, a tangent line perpendicular to the length direction of the electrode plate may be drawn at the edge of one of the second recessed portions 214, and a tangent line perpendicular to the length direction of the electrode plate may be drawn at the edge of another second recessed portion 214 that is adjacent. Finally, a connecting line segment is drawn between the two tangent lines, and the line segment does not cross any second recessed portion 214. The distance between the two tangent lines is used as the value of the distance D₃ between the two adjacent second recessed portions 214.

As an example, D₃ may be any one of 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, or 9.5 mm.

In some embodiments, as shown in FIG. 7, when the first electrode plate 21 is in an unwound state, along the thickness direction of the first electrode plate 21, the depth of the first recessed portion 213 is H₁, satisfying: 0.1 mm≤H₁≤1.5 mm. When H₁ is greater than or equal to 0.1 mm, the degree of recessing of the first electrode plate 21 at the first recessed portion 213 is not excessively small, and the clearance between the first electrode plate 21 and the separator 23 is not excessively small, thereby facilitating stress release. When H₁ is less than or equal to 1.5 mm, the degree of recessing of the first electrode plate 21 at the first recessed portion 213 is not excessively great, thereby reducing the probability of damage to the first electrode plate 21 during press-forming of the first recessed portion 213.

As an example, H₁ may be any one of 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, or 1.4 mm.

In this embodiment, the depth H₁ of the first recessed portion 213 is a distance from a surface of the first electrode plate 21 on an opening side of the first recessed portion 213 to an opening edge of the second recessed portion 214. The distance extends along the thickness direction of the first electrode plate 21.

In some embodiments, as shown in FIG. 7, when the first electrode plate 21 is in an unwound state, along the thickness direction of the first electrode plate 21, the depth of the second recessed portion 214 is H₂, satisfying: 0.1 mm≤H₂≤1.5 mm. When H₁ is greater than or equal to 0.1 mm, the degree of recessing of the first electrode plate 21 at the second recessed portion 214 is not excessively small, and the clearance between the first electrode plate 21 and the separator 23 is not excessively small, thereby facilitating stress release. When H₁ is less than or equal to 1.5 mm, the degree of recessing of the first electrode plate 21 at the second recessed portion 214 is not excessively great, thereby reducing the probability of damage to the first electrode plate 21 during press-forming of the second recessed portion 214.

As an example, H₂ may be any one of 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, or 1.4 mm. In this embodiment, the depth H₂ of the second recessed portion 214 is a distance from the edge of the opening of the second recessed portion 214 to a lowest point of the second recessed portion 214. The distance is measured along the thickness direction of the first electrode plate 21.

During measurement of H₁ and H₂, a part of the first electrode plate 21, which contains the first recessed portion 213 and the second recessed portion 214, may be taken as a sample and measured by a 3D profilometer (such as Keyence VR-5000). Touching the first recessed portion 213 and the second recessed portion 214 needs to be avoided when taking the sample.

In some embodiments, as shown in FIG. 2, the first recessed portion 213 is recessed toward the winding center of the electrode assembly 20, and the second recessed portion 214 is recessed toward the winding center of the electrode assembly 20. This makes it convenient for the first electrode plate 21 at the first recessed portion 213 and the first electrode plate 21 at the second recessed portion 214 to be in contact with and connected to the separator 23, thereby exerting a supporting force to form a clearance.

In some embodiments, as shown in FIG. 2, FIG. 8, and FIG. 9, along the thickness direction of the second electrode plate 21, the second electrode plate 22 is locally recessed in at least one of the first curved portion 203, the second curved portion 204, the first part 2011, or the third part 2013, so as to form a third recessed portion 223. The second electrode plate 22 at the third recessed portion 223 can exert a supporting force to form a clearance between the separator 23 and the second electrode plate 22 to provide deformation space for the electrode assembly 20 as a whole, thereby releasing stress and reducing stress accumulation. In addition, the first curved portion 203, the second curved portion 204, the first part 2011, and the third part 2013 are stress concentration points of the electrode assembly 20. The third recessed portion 223 is located in at least one of the first curved portion 203, the second curved portion 204, the first part 2011, or the third part 2013, thereby being more conducive to stress release in contrast to a practice in which the recessed portion is located in other positions of the electrode assembly 20. In this way, the third recessed portion 223 further reduces the probability of damage to the first electrode plate 21 and the second electrode plate 22, and prolongs the service life of the secondary battery 100.

In some embodiments, as shown in FIG. 2, FIG. 8, and FIG. 9, the second electrode plate 22 at the third recessed portion 223 is locally recessed to form a fourth recessed portion 224. The fourth recessed portion 224 and the third recessed portion 223 are recessed in the same direction. The fourth recessed portion 224 provided on the basis of the third recessed portion 223 can further increase the clearance between the second electrode plate 22 and the separator 23 to provide deformation space for the electrode assembly 20 as a whole, thereby releasing stress and further reducing the probability of damage to the first electrode plate 21 and the second electrode plate 22. In some embodiments, of the first electrode plate 21 and the second electrode plate 22, one is a positive electrode plate, and the other is a negative electrode plate. The material of a negative active material layer of the negative electrode plate includes silicon. Based on a mass of the negative active material layer, a mass percent of the silicon is 5% to 50%. The silicon-based active material exhibits an advantage of high capacity. The mass percent of silicon being greater than or equal to 5% increases the energy density of the secondary battery 100. The mass percent of silicon being less than or equal to 50% reduces the stress generated during silicon expansion, and reduces the probability of damage to the first electrode plate 21 and the second electrode plate 22.

In an existing lithium-ion battery with a silicon-based negative electrode, the volume of silicon changes during charging and discharging, resulting in expansion and contraction of the negative electrode plate. Therefore, the volume of the lithium-ion battery with a silicon-based negative electrode exhibits a greater expansion rate and contraction rate than the volume of a graphite battery during charging and discharging. With this volume change, the lithium-ion battery with a silicon-based negative electrode becomes unstable and is prone to side reactions and electrode plate fracture, thereby greatly impairing the performance of the battery and possibly posing safety hazards. When the silicon content of the negative electrode plate exceeds 5%, the effect of the volume change is more significant, and the electrode plate expands drastically, resulting in concentration of expansion stress in a corner region of the electrode plate, and in turn, causing the electrode plate to fracture. In an embodiment of this application, the first recessed portion 213 and the second recessed portion 214 provided on the first electrode plate 21 release the stress inside the electrode assembly 20, and reduce the probability of damage to the first electrode plate 21 and the second electrode plate 22, thereby prolonging the service life of the silicon-based secondary battery 100.

In an embodiment of this application, the silicon content in the secondary battery 100 may be measured by using the following method: a secondary battery 100 is discharged at a constant current of 0.1 C until the voltage reaches 3.0 V, and then the secondary battery 100 is disassembled to obtain a negative electrode plate. The negative electrode plate is cleaned with dimethyl carbonate (DMC) for 10 minutes, and then the negative electrode plate is baked at 100° C. for 2 hours for future use. The negative active material layer is scraped off from the negative electrode plate, and the powder of the negative active material layer is collected. The content of silicon and lithium in the powder of the negative electrode material layer is measured by using an inductively coupled plasma spectrometer (ICP) (model: Agilent 5800, supplied by Agilent). The content of carbon in the powder of the negative active material layer is measured by using a high-frequency carbon-sulfur analyzer (model: DK-606).

In some embodiments, the first electrode plate 21 is a positive electrode plate, and the second electrode plate 22 is a negative electrode plate.

An embodiment of this application further provides an electrode plate manufacturing method, configured to manufacture the first electrode plate 21 referred to in any one of the above embodiments. The electrode plate manufacturing method includes the following steps:
pressing, when an electrode plate is in an unwound state, a local part of the electrode plate along a thickness direction of the electrode plate to form the second recessed portion 214 on the electrode plate, where the second recessed portion is recessed along the thickness direction of the electrode plate; and
pressing, along the thickness direction of the electrode plate, an entire region at which the second recessed portion 214 is located, so as to form the first recessed portion 213 that is recessed along the thickness direction of the electrode plate; or
pressing, when an electrode plate is in an unwound state, a local part of the electrode plate along a thickness direction of the electrode plate to form the first recessed portion 213 on the electrode plate, where the first recessed portion is recessed along the thickness direction of the electrode plate; and
pressing, along the thickness direction of the electrode plate, the electrode plate at the first recessed portion 213 to form the second recessed portion 214 that is recessed along the thickness direction of the electrode plate.

In the electrode plate manufacturing method, the electrode plate is pressed twice. In other words, the second recessed portion 214 is formed first by pressing, and then the first recessed portion 213 is formed by pressing; or, the first recessed portion 213 is formed first by pressing, and then the second recessed portion 214 is formed by pressing. Compared with a practice in which the first recessed portion 213 and the second recessed portion 214 are formed by pressing at the same time, the technical solution hereof can reduce the probability of the electrode plate being damaged or even fractured during the pressing, thereby improving the yield rate of the electrode assembly 20 during manufacturing.

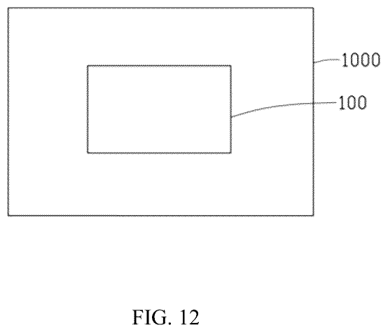

As shown in FIG. 12, an embodiment of this application further provides an electronic device 1000, including the secondary battery 100 referred to in any one of the above embodiments.

In some embodiments, the electronic device 1000 may be an unmanned aerial vehicle, an electric two-wheeler, a mobile phone, a laptop computer, a cleaning robot, an electric tool, an electric toy, or the like, which are not enumerated here exhaustively.

To explore the impact of the arrangement of the first recessed portion 213 and the second recessed portion 214 and the related dimensions thereof on the damage to the first electrode plate 21 and the second electrode plate 22, the applicant hereof has performed the following experiments. The experiments include two comparative embodiments and 29 embodiments. Each comparative embodiment and each embodiment include 20 secondary batteries. The difference between a secondary battery used in the comparative embodiments and a secondary battery used in the embodiments is that the positive electrode plate of the secondary battery used in the embodiments is provided with a first recessed portion 213 and a second recessed portion 214, with the first recessed portion 213 extending from one side of the first electrode plate 21 along the width direction to the other side of the first electrode plate 21 along the width direction; but the positive electrode plate of the secondary battery in the comparative embodiments is not provided with the first recessed portion 213 or the second recessed portion 214. The secondary batteries used in the comparative embodiments are the same as the secondary batteries used in the embodiments in all other aspects. Moreover, the secondary battery differs between different embodiments in only the parameters listed in Table 1 below. The parameters not set out in the table are the same between embodiments. The secondary batteries in the same embodiment are the same. In addition, to the extent allowable by manufacturing tolerances, W₁ and W₂ of the secondary batteries used in the embodiments are equal, and are set out in the same column in Table 1.

A method for manufacturing a secondary battery for use in the experiments includes the following steps:

### 1. Preparing a Positive Electrode Plate

Mixing lithium iron phosphate as a positive active material, acetylene black as a positive conductive agent, and polyvinylidene fluoride (PVDF, with a weight-average molecular weight of 5×10⁵) as a positive electrode binder at a mass ratio of 94:3:3, and then adding N-methylpyrrolidone (NMP) as a solvent, and stirring the mixture with a vacuum mixer until the system is homogeneous, so as to obtain a positive electrode slurry in which the solid content is 75 wt %. Using 8 μm-thick aluminum foil as a positive current collector, and cutting the aluminum foil to form an inner positive tab. Coating one surface of positive current collector aluminum foil with the positive electrode slurry evenly, and drying the slurry at 110° C. to obtain a positive electrode plate coated with an 80 μm-thick positive active material layer on a single side. Subsequently, repeating the above steps on the other surface of the aluminum foil to obtain a positive electrode plate coated with the positive active material layer on both sides.

The preparation method for the positive electrode plate used in the embodiments further includes, in addition to the above steps, a step of forming a first recessed portion 213 and a second recessed portion 214 by pressing on the positive electrode plate, the details of which may be learned with reference to the description above and are not repeated here. After the press-forming is completed, the number of the first recessed portions 213 is 1, and the number of the second recessed portions 214 is 10. The second recessed portions 214 are hemispherical, and the openings of the second recessed portions 214 are circular. The 10 second recessed portions 214 are arranged in the first recessed portion 213 in an array that includes 5 rows and two columns. The distance between any two adjacent second recessed portions 214 is equal. The arrangement direction of the rows is the length direction of the positive electrode plate, and the arrangement direction of the columns is the width direction of the positive electrode plate. In a subsequent winding process of the positive electrode plate, the positive electrode plate is wound along the length direction thereof.

### 2. Preparing a Negative Electrode Plate

Mixing graphite powder and silicon powder as a negative active material, conductive carbon black (Super P) as a conductive agent, and styrene-butadiene rubber (SBR) as a binder at a mass ratio of 67.5:30:1:1.5, and then adding deionized water as a solvent to formulate a negative electrode slurry in which the solid content is 50 wt %, and stirring well. Using 5 μm-thick copper foil as a negative current collector, and cutting the copper foil to form an inner negative tab. Coating one surface of the negative current collector copper foil with the negative electrode slurry evenly, and drying the slurry at 90° C. to obtain a negative electrode plate coated with a negative active material layer on a single side. The coating on a single side of the negative electrode plate is completed upon completion of the above steps. Subsequently, repeating the above steps on the other surface of the negative electrode plate to obtain a negative electrode plate coated with the negative active material layer on both sides.

### 3. Preparing a Separator

Using an 8 μm-thick polyethylene (PE) porous thin film as a separator.

### 4. Preparing an Electrolyte Solution

Mixing ethylene carbonate, ethyl methyl carbonate, and diethyl carbonate at a mass ratio of 30:50:20 in an dry argon atmosphere to obtain an organic solvent, and then adding lithium hexafluorophosphate as a lithium salt into the organic solvent to dissolve, and stirring well to obtain an electrolyte solution in which the lithium salt concentration is 1.15 mol/L.

### 5. Preparing a Lithium-Ion Battery

Stacking sequentially the separator, the positive electrode plate, the separator, and the negative electrode plate that are prepared above, and winding the stacked structure to obtain an electrode assembly, in which the first recessed portion 213 is located at the first curved portion. Hot-pressing the electrode assembly at a pressure of 5 MPa, a temperature of 65° C., and for a holding time of 10 seconds. Placing the electrode assembly into an aluminum laminated film packaging bag, and letting both the positive tab and the negative tab extend out from a top seal edge of the packaging bag. Dehydrating the packaged electrode assembly at 80° C., and then injecting an electrolyte solution, and sealing the packaging bag.

After the secondary battery is prepared, the following experimental steps are performed for both the comparative embodiments and the embodiments:

Charge-and-discharge cycling test: Charging the above-prepared secondary battery at a constant current of 0.5 C at a normal temperature of 25° C., and then charging the battery at a constant voltage of 0.05 C until an upper cut-off voltage. Leaving the battery to stand for 30 minutes, and then discharging the battery at 1 C until a lower cut-off voltage, thereby completing one charge-and-discharge cycle. Repeating the above steps for 500 cycles. Disassembling the secondary battery, and observing the tearing of the first electrode plate 21 and the second electrode plate 22.

The parameters involved in the experiments and the results of experimental observations are recorded to obtain the following Table 1. In Table 1, R represents the diameter of the opening of the second recessed portion 214, D₃ represents the distance between two adjacent second recessed portions 214, H₁ represents the depth of the first recessed portion 213, and H₂ represents the depth of the second recessed portion 214. The values of R, D₃, H₁, and H₂ are measured after completion of manufacturing the positive electrode plate. The units of R, D₃, H₁, and H₂ are all millimeters (mm). The electrode plate tear rate is a ratio of the number of secondary batteries with either the first electrode plate 21 or the second electrode plate 22 torn up in a group to the total number of secondary batteries in the group.

TABLE 1

| | | Are first recessed | | | | | | |
|---|---|---|---|---|---|---|---|---|
| | Are first recessed | portion and second | | | | | | |
| | portion and second | recessed portion | | | | | | Electrode |
| Experimental | recessed portion | recessed in the | | | | | W₁ | plate tear |
| group | existent? | same direction? | R | D₃ | H₁ | H₂ | (W₂) | rate |
| Comparative | No | / | / | / | / | / | / | 18/20 |
| Embodiment 1 | | | | | | | | |
| Comparative | Yes | No | 0.5 | 5 | 1 | 1 | 3 | 17/20 |
| Embodiment 2 | | | | | | | | |
| Embodiment 1 | Yes | Yes | 0.5 | 5 | 1 | 1 | 3 | 12/20 |
| Embodiment 2 | Yes | Yes | 1 | 5 | 1 | 1 | 3 | 5/20 |
| Embodiment 3 | Yes | Yes | 3 | 5 | 1 | 1 | 3 | 3/20 |
| Embodiment 4 | Yes | Yes | 5 | 5 | 1 | 1 | 3 | 4/20 |
| Embodiment 5 | Yes | Yes | 7 | 5 | 1 | 1 | 3 | 11/20 |
| Embodiment 6 | Yes | Yes | 3 | 0.3 | 1 | 1 | 3 | 8/20 |
| Embodiment 7 | Yes | Yes | 3 | 0.5 | 1 | 1 | 3 | 2/20 |
| Embodiment 8 | Yes | Yes | 3 | 1 | 1 | 1 | 3 | 0/20 |
| Embodiment 9 | Yes | Yes | 3 | 4 | 1 | 1 | 3 | 0/20 |
| Embodiment 10 | Yes | Yes | 3 | 6 | 1 | 1 | 3 | 2/20 |
| Embodiment 11 | Yes | Yes | 3 | 8 | 1 | 1 | 3 | 1/20 |
| Embodiment 12 | Yes | Yes | 3 | 10 | 1 | 1 | 3 | 3/20 |
| Embodiment 13 | Yes | Yes | 3 | 12 | 1 | 1 | 3 | 10/20 |
| Embodiment 14 | Yes | Yes | 3 | 5 | 0.05 | 1 | 3 | 8/20 |
| Embodiment 15 | Yes | Yes | 3 | 5 | 0.1 | 1 | 3 | 5/20 |
| Embodiment 16 | Yes | Yes | 3 | 5 | 0.5 | 1 | 3 | 2/20 |
| Embodiment 17 | Yes | Yes | 3 | 5 | 1.5 | 1 | 3 | 5/20 |
| Embodiment 18 | Yes | Yes | 3 | 5 | 2 | 1 | 3 | 12/20 |
| Embodiment 19 | Yes | Yes | 3 | 5 | 1 | 0.05 | 3 | 9/20 |
| Embodiment 20 | Yes | Yes | 3 | 5 | 1 | 0.1 | 3 | 6/20 |
| Embodiment 21 | Yes | Yes | 3 | 5 | 1 | 0.5 | 3 | 4/20 |
| Embodiment 22 | Yes | Yes | 3 | 5 | 1 | 1.5 | 3 | 1/20 |
| Embodiment 23 | Yes | Yes | 3 | 5 | 1 | 2 | 3 | 13/20 |
| Embodiment 24 | Yes | Yes | 3 | 5 | 1 | 1 | 0.8 | 8/20 |
| Embodiment 25 | Yes | Yes | 3 | 5 | 1 | 1 | 1 | 3/20 |
| Embodiment 26 | Yes | Yes | 3 | 5 | 1 | 1 | 2 | 0/20 |
| Embodiment 27 | Yes | Yes | 3 | 5 | 1 | 1 | 4 | 2/20 |
| Embodiment 28 | Yes | Yes | 3 | 5 | 1 | 1 | 5 | 4/20 |
| Embodiment 29 | Yes | Yes | 3 | 5 | 1 | 1 | 6 | 9/20 |

As can be seen from Table 1, compared with Comparative Embodiments 1 and 2, the secondary batteries 100 in Embodiments 1 to 29 are provided with a first recessed portion 213 and a second recessed portion 214 at the first electrode plate 21, and the first recessed portion 213 and the second recessed portion 214 are recessed in the same direction. The first recessed portion 213 and the second recessed portion 214 can exert a supporting force to form a clearance between the separator 23 and the first electrode plate 21 to provide deformation space for the electrode assembly, thereby releasing stress and reducing stress accumulation. Therefore, in Embodiments 1 to 29, the electrode plate tear rate is less than that in Comparative Embodiments 1 to 2.

Compared with Embodiments 1 and 5, the diameter of the inscribed circle of the opening of the second recessed portion 214 in a secondary battery 100 in Embodiments 2 to 4 is R, satisfying: 1 mm≤R≤5 mm. Under this condition, the value of R is not excessively small, and the pressure on the first electrode plate 21 during press-forming of the second recessed portion 214 is not excessively large, thereby reducing the probability of damage to the first electrode plate 21 during press-forming of the second recessed portion 214. Under this condition, the value of R is not excessively large, and each second recessed portion 214 does not occupy an excessively large area on the surface of the first electrode plate 21, thereby enabling arrangement of a larger number of second recessed portions 214, and in turn, improving the supporting effect of the first electrode plate 21 at the second recessed portion 214 for the separator 23. Therefore, the electrode plate tear rate in Embodiments 2 to 4 is less than that in Embodiments 1 and 5.

Compared with Embodiments 6 and 13, the secondary batteries 100 in Embodiment 3 and Embodiments 7 to 12 satisfy 0.5 mm≤D₃≤10 mm. Under this condition, the distance between two adjacent second recessed portions 214 is not excessively short, thereby reducing the probability of damage to the first electrode plate 21 due to the formation of the second recessed portion 214; and the distance between two adjacent second recessed portions 214 is not excessively long, thereby increasing the number of second recessed portions 214 per unit area of the first electrode plate 21, improving the supporting effect of the second recessed portion 214 for the separator 23, and in turn, maintaining the clearance between the separator 23 and the first electrode plate 21. Therefore, the electrode plate tear rate in Embodiments 7 to 12 is less than that in Embodiments 6 and 13.

Compared with Embodiments 14 and 18, the secondary batteries 100 in Embodiment 3 and Embodiments 15 to 17 satisfy 0.1 mm≤H₁≤1.5 mm. Under this condition, the value of H₁ is not excessively small, the degree of recessing of the first electrode plate 21 at the first recessed portion 213 is not excessively small, and the clearance between the first electrode plate 21 and the separator 23 is not excessively small, thereby facilitating stress release. Under this condition, the value of H₂ is not excessively large, and the degree of recessing of the first electrode plate 21 at the first recessed portion 213 is not excessively great, thereby reducing the probability of damage to the first electrode plate 21 during press-forming of the first recessed portion 213. Therefore, the electrode plate tear rate in Embodiments 15 to 17 is less than that in Embodiments 14 and 18.

Compared with Embodiments 19 and 23, the secondary batteries 100 in Embodiment 3 and Embodiments 20 to 22 satisfy 0.1 mm≤H₂≤1.5 mm. Under this condition, the value of H₂ is not excessively small, the degree of recessing of the first electrode plate 21 at the second recessed portion 214 is not excessively small, and the clearance between the first electrode plate 21 and the separator 23 is not excessively small, thereby facilitating stress release. Under this condition, the value of H₂ is not excessively large, and the degree of recessing of the first electrode plate 21 at the second recessed portion 214 is not excessively great, thereby reducing the probability of damage to the first electrode plate 21 during press-forming of the second recessed portion 214. Therefore, the electrode plate tear rate in Embodiments 20 to 22 is less than that in Embodiments 19 and 23.

Compared with Embodiments 24 and 29, the secondary batteries 100 in Embodiment 3 and Embodiments 25 to 28 satisfy 1 mm≤W₁≤5 mm and 1 mm≤W₂≤5 mm. Under this condition, the distance between the edge of the first recessed portion 213 and the second recessed portion 214 is not excessively small, thereby reducing the probability of damage to the first electrode plate 21 during press-forming of the second recessed portion 214. Under this condition, the distance between the edge of the first recessed portion 213 and the second recessed portion 214 is not excessively large, thereby improving the supporting effect of the second recessed portion 214 for the separator 23, and releasing stress during expansion of the electrode assembly 20. Therefore, the electrode plate tear rate in Embodiments 25 to 28 is less than that in Embodiments 24 and 29.

In addition, a person of ordinary skill in the art understands that the foregoing embodiments are merely intended to illustrate this application, but not intended to limit this application. Any and all appropriate modifications and changes made to the embodiments without departing from the essence of this application still fall within the protection scope of this application.

What is claimed is:

1. A secondary battery, wherein, the secondary battery comprises:
a housing; and
an electrode assembly disposed in the housing;
wherein, the electrode assembly comprises a first electrode plate, a second electrode plate, and a separator disposed between the first electrode plate and the second electrode plate; the first electrode plate, the second electrode plate, and the separator are stacked and wound to form a jelly-roll structure; wherein,
along a winding direction of the electrode assembly, the electrode assembly comprises a first straight portion, a first curved portion, a second straight portion, and a second curved portion that are disposed sequentially; the first straight portion and the second straight portion each comprise a first part, a second part, and a third part disposed sequentially; the first part is connected to the first curved portion and the second part, the third part is connected to the second curved portion and the second part; and along the winding direction of the electrode assembly, a length of the first part is D₁, and a length of the third part is D₂, wherein,
$$0 \leq {D}_{1} \leq 5 mm , 0 \leq {D}_{2} \leq 5 mm ;$$
along a thickness direction of the first electrode plate, the first electrode plate is recessed in at least one of the first curved portion, the second curved portion, the first part, or the third part, so as to form at least one first recessed portion; at least one second recessed portion is provided in each first recessed portion; and
the each first recessed portion and the at least one second recessed portion in the each first recessed portion are recessed in a same direction.

2. The secondary battery according to claim 1, wherein, at least one of the at least one first recessed portion is provided at the first curved portion, and/or
at least an other one of the at least one first recessed portion is provided at the second curved portion.

3. The secondary battery according to claim 1, wherein, along the winding direction of the electrode assembly, an outermost turn of the first electrode plate is provided with the at least one first recessed portion; and/or
a second turn from the outside of the first electrode plate is provided with the at least one first recessed portion.

4. The secondary battery according to claim 1, wherein, along a winding center axis direction of the electrode assembly, the at least one first recessed portion extends from one side of the first electrode plate to another side of the first electrode plate.

5. The secondary battery according to claim 4, wherein, each second recessed portion is in a shape that is at least one of a dot-shaped recess, a reticular recess, or a striped recess.

6. The secondary battery according to claim 4, wherein, the secondary battery comprises a plurality of first recessed portions; and/or
a plurality of second recessed portions are provided within at least one of the first recessed portions.

7. The secondary battery according to claim 6, wherein, the plurality of second recessed portions are provided within the at least one of the first recessed portions, and the first recessed portion comprises a first edge and a second edge disposed opposite to each other along a length direction of the first electrode plate;
among the plurality of second recessed portions, a minimum distance between a second recessed portion closest to the first edge and the first edge is W₁, 1 mm≤W₁≤5 mm; and
among the plurality of second recessed portions, a minimum distance between a second recessed portion closest to the second edge and the second edge is W₂, 1 mm≤W₂≤5 mm.

8. The secondary battery according to claim 1, wherein, when the first electrode plate is in an unwound state, a diameter of an inscribed circle of an opening of the second recessed portion, the opening being located on a surface of the first electrode plate, is R, 1 mm≤R≤5 mm.

9. The secondary battery according to claim 8, wherein, a plurality of second recessed portions are provided within at least one of the first recessed portions, and a distance between two adjacent second recessed portions within a same first recessed portion is D₃, 0.5 mm≤D₃≤10 mm.

10. The secondary battery according to claim 8, wherein, when the first electrode plate is in an unwound state, along the thickness direction of the first electrode plate, a depth of the first recessed portion is H₁, 0.1 mm≤H₁≤1.5 mm; and/or
when the first electrode plate is in an unwound state, along the thickness direction of the first electrode plate, a depth of the second recessed portion is H₂, 0.1 mm≤H₂≤1.5 mm.

11. The secondary battery according to claim 1, wherein, the first recessed portion is recessed toward a winding center of the electrode assembly, and the second recessed portion is recessed toward the winding center of the electrode assembly.

12. The secondary battery according to claim 1, wherein, along a thickness direction of the second electrode plate, the second electrode plate is recessed in at least one of the first curved portion, the second curved portion, the first part, or the third part, so as to form a third recessed portion; the second electrode plate at the third recessed portion is recessed to form a fourth recessed portion provided within the third recessed portion, and the fourth recessed portion and the third recessed portion are recessed in a same direction.

13. The secondary battery according to claim 1, wherein, one of the first electrode plate and the second electrode plate, is a positive electrode plate, and the other is a negative electrode plate; the negative electrode plate comprises a negative current collector and a negative active material layer that are stacked together; a material of the negative active material layer comprises silicon; and based on a mass of the negative active material layer, a mass percent of the silicon is 5% to 50%.

14. An electronic device, the electronic device comprises a secondary battery, wherein, the secondary battery comprises:
a housing; and
an electrode assembly disposed in the housing;
wherein, the electrode assembly comprises a first electrode plate, a second electrode plate, and a separator disposed between the first electrode plate and the second electrode plate; the first electrode plate, the second electrode plate, and the separator are stacked and wound to form a jelly-roll structure; wherein,
along a winding direction of the electrode assembly, the electrode assembly comprises a first straight portion, a first curved portion, a second straight portion, and a second curved portion that are disposed sequentially; the first straight portion and the second straight portion each comprise a first part, a second part, and a third part disposed sequentially; the first part is connected to the first curved portion and the second part, the third part is connected to the second curved portion and the second part; and along the winding direction of the electrode assembly, a length of the first part is D₁, and a length of the third part is D₂, wherein,
$$0 \leq {D}_{1} \leq 5 mm , 0 \leq {D}_{2} \leq 5 mm ;$$
along a thickness direction of the first electrode plate, the first electrode plate is recessed in at least one of the first curved portion, the second curved portion, the first part, or the third part, so as to form at least one first recessed portion; at least one second recessed portion is provided in each first recessed portion; and
the each first recessed portion and the at least one second recessed portion in the each first recessed portion are recessed in a same direction.

15. The electronic device according to claim 14, wherein, at least one of the at least one first recessed portion is provided at the first curved portion, and/or
at least an other one of the at least one first recessed portion is provided at the second curved portion.

16. The electronic device according to claim 14, wherein, along the winding direction of the electrode assembly, an outermost turn of the first electrode plate is provided with the at least one first recessed portion; and/or
a second turn from the outside of the first electrode plate is provided with the at least one first recessed portion.

17. The electronic device according to claim 14, wherein, along a winding center axis direction of the electrode assembly, the at least one first recessed portion extends from one side of the first electrode plate to another side of the first electrode plate.

18. The electronic device according to claim 17, wherein, each second recessed portion is in a shape that is at least one of a dot-shaped recess, a reticular recess, or a striped recess.

19. The electronic device according to claim 17, wherein, the secondary battery comprises a plurality of first recessed portions; and/or
a plurality of second recessed portions are provided within at least one of the first recessed portions.

20. A method for manufacturing the first electrode plate of the secondary battery according to claim 1, the method comprises following steps:
pressing, when an electrode plate is in an unwound state, a local part of the electrode plate along a thickness direction of the electrode plate to form the second recessed portion on the electrode plate, wherein the second recessed portion is recessed along the thickness direction of the electrode plate; and
pressing, along the thickness direction of the electrode plate, an entire region at which the second recessed portion is located, so as to form the first recessed portion that is recessed along the thickness direction of the electrode plate; or
pressing, when an electrode plate is in an unwound state, a local part of the electrode plate along a thickness direction of the electrode plate to form the first recessed portion on the electrode plate, wherein the first recessed portion is recessed along the thickness direction of the electrode plate; and
pressing, along the thickness direction of the electrode plate, the electrode plate at the first recessed portion to form the second recessed portion that is recessed along the thickness direction of the electrode plate.
